(19) United States
(12) Patent Application Publication
(10) Pub. No.: US 2016/0027416 A1
(43) Pub. Date: Jan. 28, 2016

(54) MUSIC INSTRUMENT STAND

(71) Applicant: Chia-Chun Hsu, Taichung City (TW)

(72) Inventor: Chia-Chun Hsu, Taichung City (TW)

(21) Appl. No.: 14/339,466

(22) Filed: Jul. 24, 2014

(51) Int. Cl. G10G 5/00; F16M 11/04; F16M 11/22; H04R 1/08

(52) U.S. Cl. CPC G10G 5/00; H04R 1/08; F16M 11/04; F16M 11/22

(57) ABSTRACT

A music instrument stand includes a base, three legs and a shaft. The base has three recesses and a positioning hole defined in the top thereof. Three reception slots are defined in the underside of the base and communicate through the periphery of the base. The three reception slots are located at even distance and angle from each other. The three legs are pivotably received in the three reception slots. The shaft extends through the positioning hole. At least one attachment is connected to the shaft to position or support a music instrument.

### BACKGROUND OF THE INVENTION

1. Fields of the Invention

The present invention relates to a music instrument stand, and more particularly, to a music instrument stand with multiple attachments for positioning and/or supporting different music instruments.

2. Description of the Prior Art

The conventional music instrument stand is used to support or position the instrument when playing, so that the player does not have to hold the instrument.

There are different types music instruments which have different shapes and sizes, such as woodwinds, brasses and stringed instruments. The woodwinds include flutes, clarinets, oboes, saxophones, English horns, and bassoons. The brasses include trombones, trumpets, tubas, sousaphones, French horns, cornets, tubas, baritones and bugles. The stringed instruments include guitars, mandolins, banjos, sitars, Appalachian dulcimers and ukuleles, and Chinese stringed instruments. Generally, each instrument can only be positioned or support by an individual and special designed stand. That means the players who play multiple music instruments will have to prepare several different music instrument stands for the different music instruments. There is a multiple-function music instrument stand which his able to position or support different music instruments, however, the multiple-function music instrument stand includes a complicated structure and occupies a certain space. There are many rivets, pins and bolts involved for the multiple-function music instrument stand, and the multiple-function music instrument stand does not have a stable and low gravity center so that it easily falls.

The present invention intends to provide a music instrument stand which eliminates the shortcomings mentioned above.

### SUMMARY OF THE INVENTION

The present invention relates to a music instrument stand and comprises a base having at least three recesses and a positioning hole defined in the top thereof. At least three reception slots are defined in the underside of the base and communicate through the periphery of the base.

The at least three reception slots are located at even distance and angle from each other. Each of the at least three reception slots has an inclined inner top. At least three legs each have an insertion end located in one of the at least three recesses. The at least three legs are received in the at least three reception slots and contact against the three inclined inner tops. A shaft has an end inserted through the positioning hole and at least one attachment is connected to the shaft.

Preferably, the at least one attachment is a support which has a bolt and a through hole. A first slot and a second slot are defined in the top thereof. The shaft extends through the through hole and the bolt contacts against the shaft. The attachment is able to position a woodwind, a brass and a stringed instrument.

Preferably, the at least one attachment is a Y-shaped member which has a bolt and a through hole. The shaft extends through the through hole and the bolt contacts against the shaft. The Y-shaped member has a yoke portion which has two distal ends between which a wire is connected. The attachment is able to position a stringed instrument.

Preferably, the at least one attachment is a clip member which has a bolt and a through hole. The shaft extends through the through hole and the bolt contacts against the shaft. The clip member has a notch and an insertion hole. A hook-rod extends through the insertion hole. A spring is received insertion hole and mounted to the hook-rod. The hook-rod has a lip extending outward therefrom, and the spring is biased between the lip and the inside of the insertion hole. The hook-rod has a hook end which hooks an object in the notch. The hook-rod is pushed to open the notch and the notch is closed when the hook-rod is released. The clip member can be pivoted 90 degrees to position other music instrument.

Preferably, the at least one attachment is a music support which has a tube at the center thereof. The shaft extends through the tube and a bolt extends through the tube and contacts against the shaft.

Preferably, the at least one attachment is a curved clip which has a bolt and a through hole. The shaft extends through the through hole and the bolt contacts against the shaft. The curved clip clips a microphone.

The primary object of the present invention is to provide a music instrument stand which occupies a smaller space and can position or support multiple types of music instruments.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the music instrument stand with a Y-shaped member and a support of the present invention;

FIG. 2 is an exploded view to show the music instrument stand with a Y-shaped member and a support of the present invention;

FIG. 3 is a plan view to show the base of the music instrument stand of the present invention;

FIG. 4 shows the operation of the legs relative to the base of the music instrument stand of the present invention;

FIG. 5 is a side view to show that a guitar is supported by the music instrument stand with the Y-shaped member and the support of the present invention;

FIG. 6 is a front view to show that a guitar is supported by the music instrument stand with the Y-shaped member and the support of the present invention;

FIG. 7 is a perspective view to show the clip member of the present invention;

FIG. 8 is a cross sectional view to show that the hook-rod of the clip member of the present invention is pushed;

FIG. 9 is a cross sectional view to show that the notch of the clip member of the present invention is closed;

FIG. 10 shows a music instrument is positioned by the music instrument stand with the Y-shaped member and the support of the present invention;

FIG. 11 is a perspective view to show the curved clip of the present invention;

FIG. 12 shows that a microphone is positioned by the curved clip of the present invention;

FIG. 13 shows the music support is cooperated with the music instrument stand of the present invention;

FIG. 14 shows that a trumpet is supported by the shaft of the music instrument stand of the present invention;

FIG. 15 shows that a ring of the trumpet is positioned by the clip member of the music instrument stand of the present invention;

FIG. 16 shows that a ring of the saxophone is positioned by the clip member of the music instrument stand of the present invention;

FIG. 17 shows that the shaft, the base and the legs are received in the trumpet.

### DETAILED DESCRIPTION OF THE PREFERRED EMBODIMENT

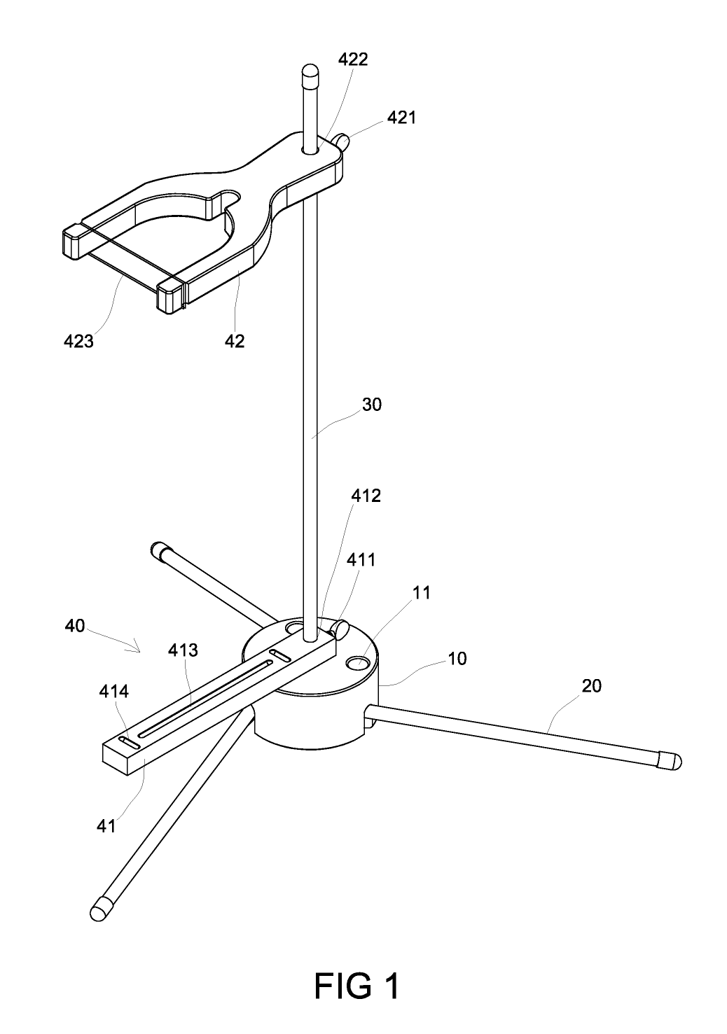

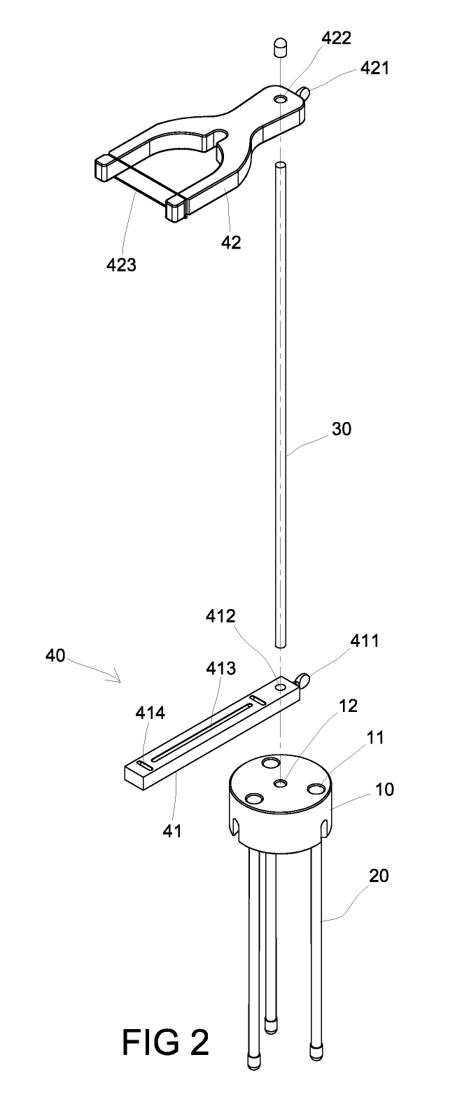

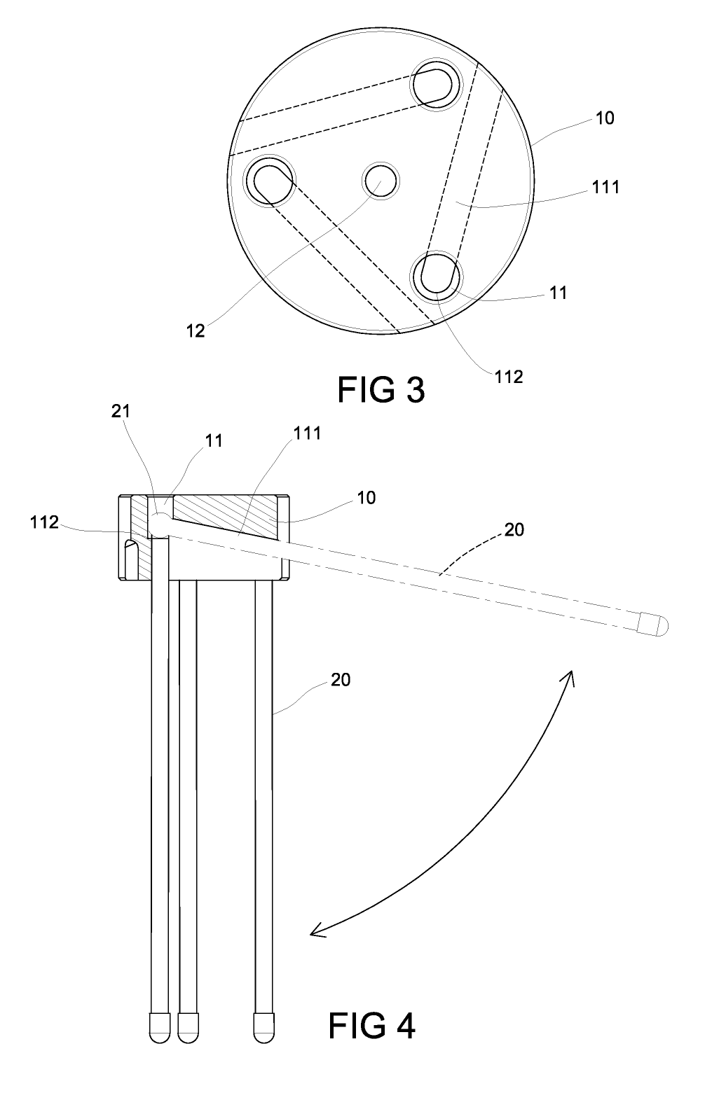

Referring to FIGS. 1 to 4, the music instrument stand of the present invention comprises a base 10, three legs 20 and a shaft 30. The base 10 can be a round disk, a triangular disk, a rectangular disk, a ball or a block. Three recesses 11 and a positioning hole 12 are defined in the top of the base 10. Three reception slots 111 are defined in the underside of the base 10 and communicate through the periphery of the base 10. The three reception slots 111 are located at even distance and angle from each other. Each of the three reception slots 111 has an inclined inner top so that the thickness of the base 10 at each reception slot 111 is gradually thinner toward the recess 11. Each of the three recesses 11 has a flange 112 extending inward from the inner periphery thereof. The insertion end of each of the legs 20 has a spherical head 21 which is smaller than the inner diameter of each of the three recesses 11 and larger than the inner diameter of the flange 112 of each of the three recesses 11. Therefore, the spherical head 21 of each leg is pivotably located in the recess 11 and pivotable relative to the flange 112. The legs 20 each are pivoted an angle to be received in the three reception slot 111 and contacts against the inclined inner top to support the bas 10. The shaft 30 has an end inserted through the positioning hole and at least one attachment 40 is connected to the shaft 30.

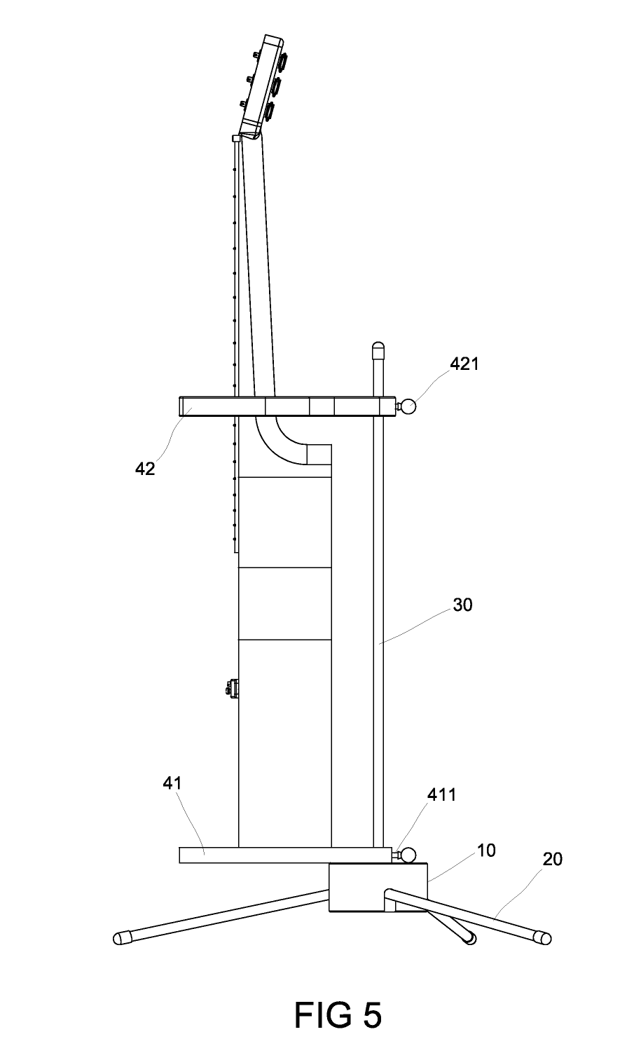

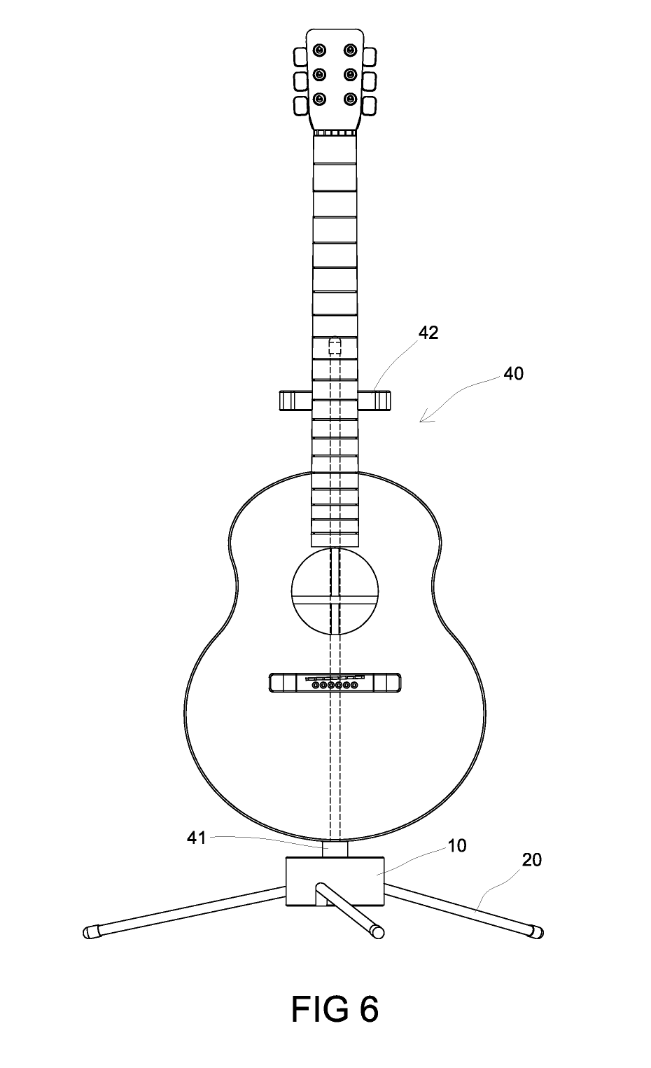

As shown in FIGS. 1, 2, 5 and 6, the at least one attachment 40 is a support 41 which has a bolt 411 and a through hole 412. A first slot 413 and two second slots 414 are defined in the top thereof. The shaft 30 extends through the through hole 412 and the bolt 411 contacts against the shaft 30. The two second slots 414 are parallel to each other. The first and second slots 413, 414 prevent the woodwind, the brass and the stringed instrument from slipping. The support 41, the shaft 30 and the base 10 support the woodwind, the brass and the stringed instrument while the music instrument stand occupies a limited space.

As shown in FIGS. 1, 2, 5 and 6, the at least one attachment 40 is a Y-shaped member 42 which has a bolt 421 and a through hole 422. The shaft 30 extends through the through hole 422 and the bolt 421 contacts against the shaft 30. The Y-shaped member 42 has a yoke portion which has two distal ends between which a wire 423 is connected.

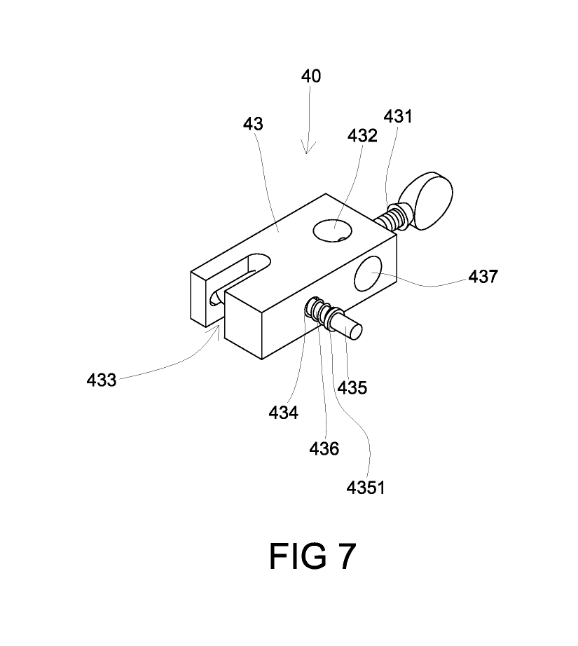

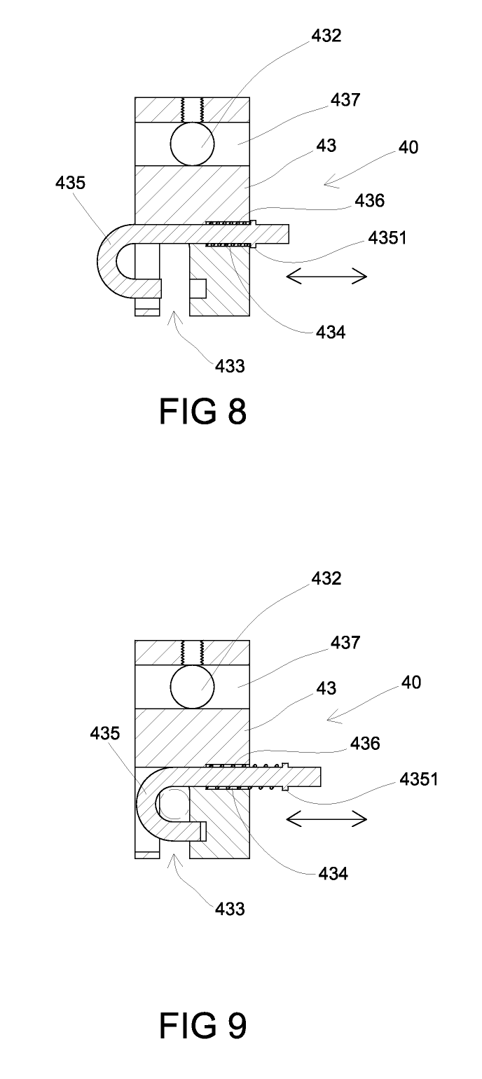

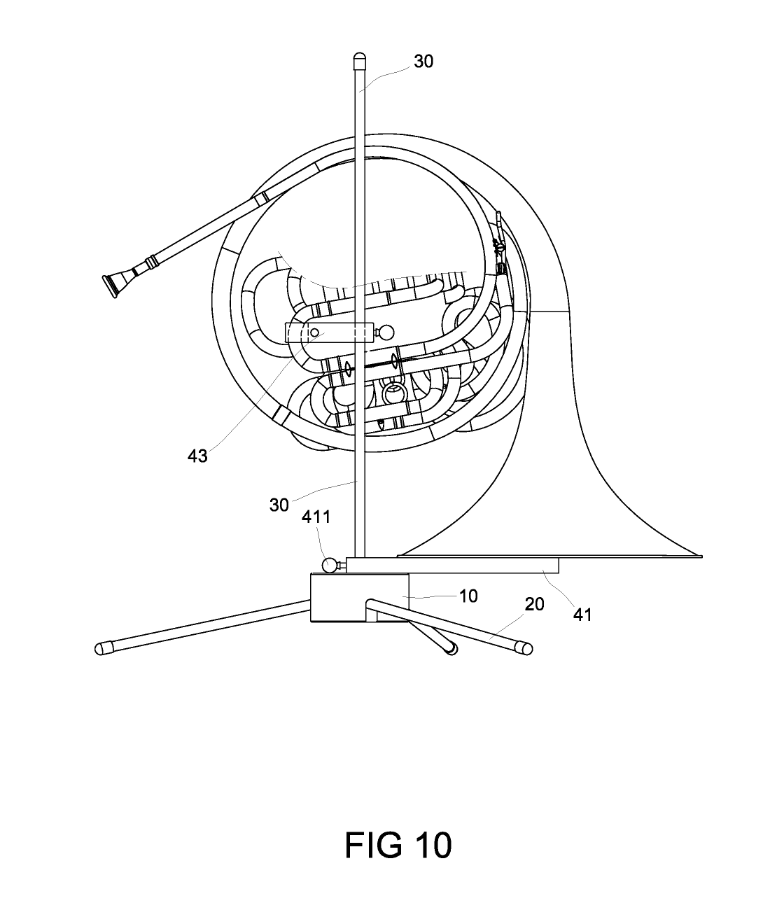

As shown in FIGS. 7 to 10, the at least one attachment 40 is a clip member 43 which has a bolt 431 and a through hole 432. The shaft 30 extends through the through hole 432 and the bolt 431 contacts against the shaft 30. The clip member 43 has a notch 433 and an insertion hole 434. A hook-rod 435 extends through the insertion hole 434. A spring 436 is received insertion hole 434 and mounted to the hook-rod 435. The hook-rod 435 has a lip 4351 extending outward therefrom. The spring 436 is biased between the lip 4351 and an inside of the insertion hole 434. The hook-rod 435 has a hook end which hooks a music instrument in the notch 433. The hook-rod 435 is pushed to open the notch 433 and the notch 433 is closed when the hook-rod 435 is released. The clip member 43 has a side hole 437 and the shaft 30 extends through the side hole 437. The bolt 431 contacts against the shaft 30 to position the shaft 30. The clip member 43 can be pivoted 90 degrees to position other instrument.

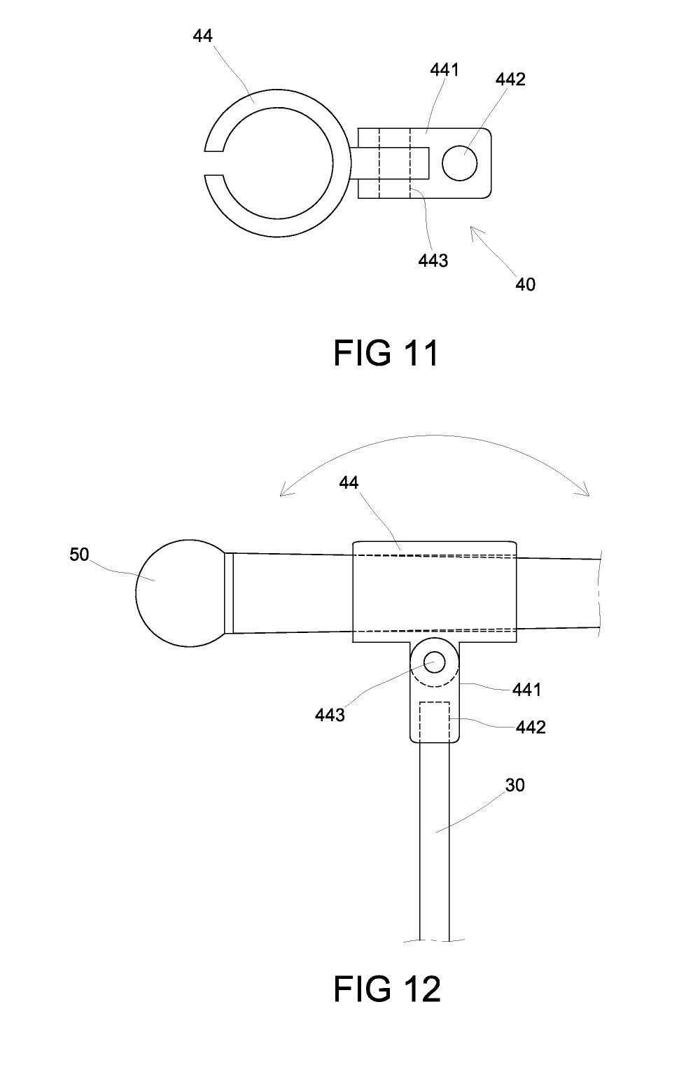

As shown in FIGS. 11 to 12, the at least one attachment 40 is a curved clip 44 which has a shank 441 and a recess 442 in which the shaft 30 is inserted. The shank 441 is pivotably connected to the curved clip 44 by a rivet 443. The curved clip 44 is pivotable to adjust the angle. The curved clip 44 is able to clip a microphone 50.

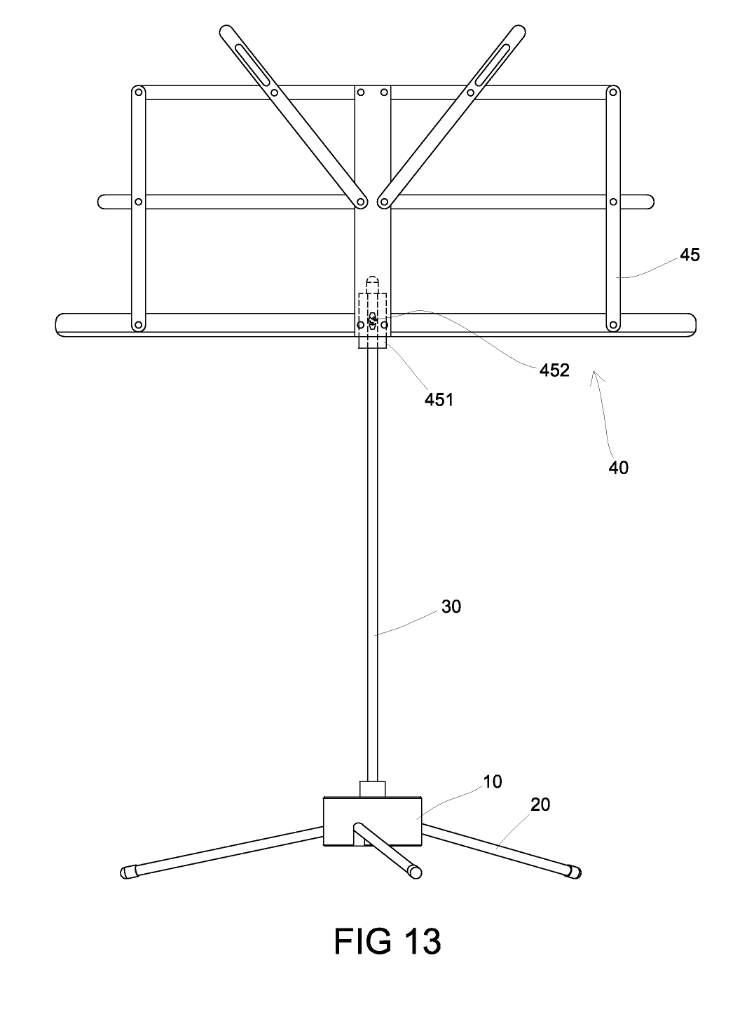

As shown in FIG. 13, the at least one attachment 40 is a music support 45 which has a tube 451 at the center thereof. The shaft 30 extends through the tube 451 and a bolt 452 extends through the tube 451 and contacts against the shaft 30.

When in use, the legs 20 are respectively inserted into the three recesses 11 of the base 10 until the spherical heads 21 are in contact with the flanges 112 respectively, and the legs 20 are then pivoted an angle to be received in the three reception slots 111. The three legs 20 evenly support the base 10 and occupy a minimum area. By this arrangement, the base 10 and the legs 20 are able to support the object of two times of the length and the area of those of the legs 20 and the base 10. The shaft 30 is then inserted into the positioning hole 12 and can be support a flute, a clarinet, an oboe, a saxophone, a trumpet or a French horn. The attachments 40 position different types of music instruments.

The clip member 43 as shown in FIGS. 7-10 can position the ring of a saxophone. When cooperated with the support 41, a soprano saxophone, an alto saxophone and a tenor saxophone are positioned. When the clip member 43 and the support 41 are removed, the base 10 can be received in the soprano saxophone. The shaft 30 can be inserted into the alto saxophone and the tenor saxophone. The base 10 can be received in the bell portion of the alto saxophone and the tenor saxophone.

When the clip member 43 is pivoted 90 degrees, the notch 433 becomes an upright notch to hold the brass instrument, the three-part instrument or the reinforcement portion of the instrument. When cooperated with the support 41, the weight center of the instrument is located close to the shaft 30 so that the instrument can be supported upright. A tuba, a baritone horn, an alto horn and a trumpet, a French horn or a trombone is suitable to be positioned by the music instrument stand.

The Y-shaped member 42 and the support 41 are attached to the shaft 30 to hold the stringed instrument such as a guitar, a violin, an electric guitar, an electric bass, an ukulele, a alto violin, a Chinese stringed instrument such as erhu and pipa.

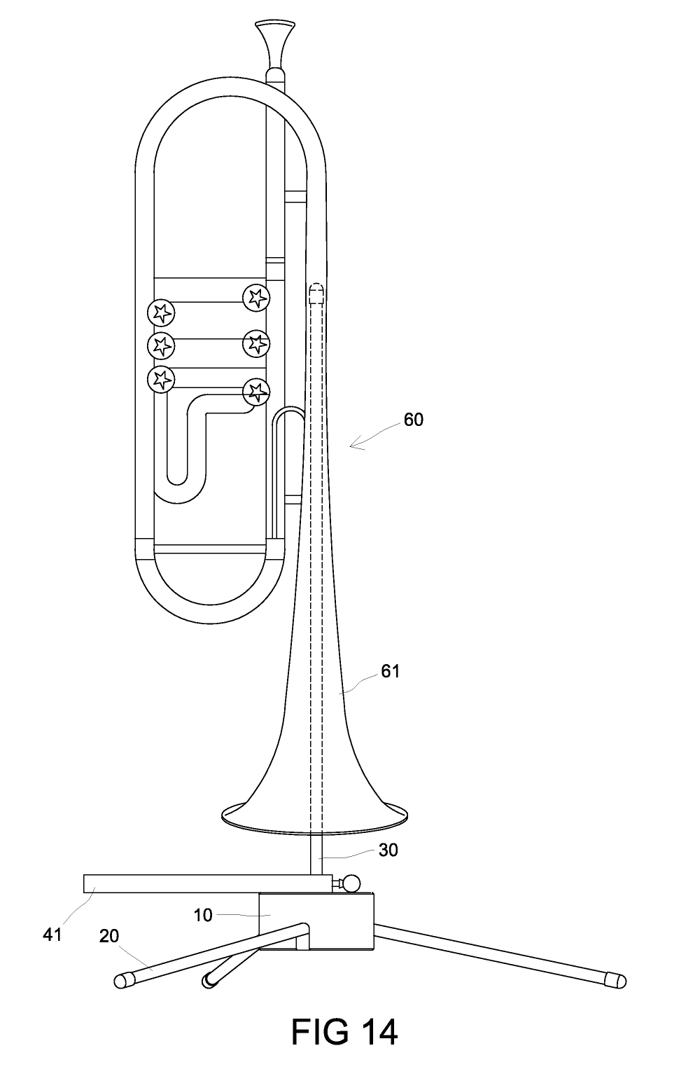

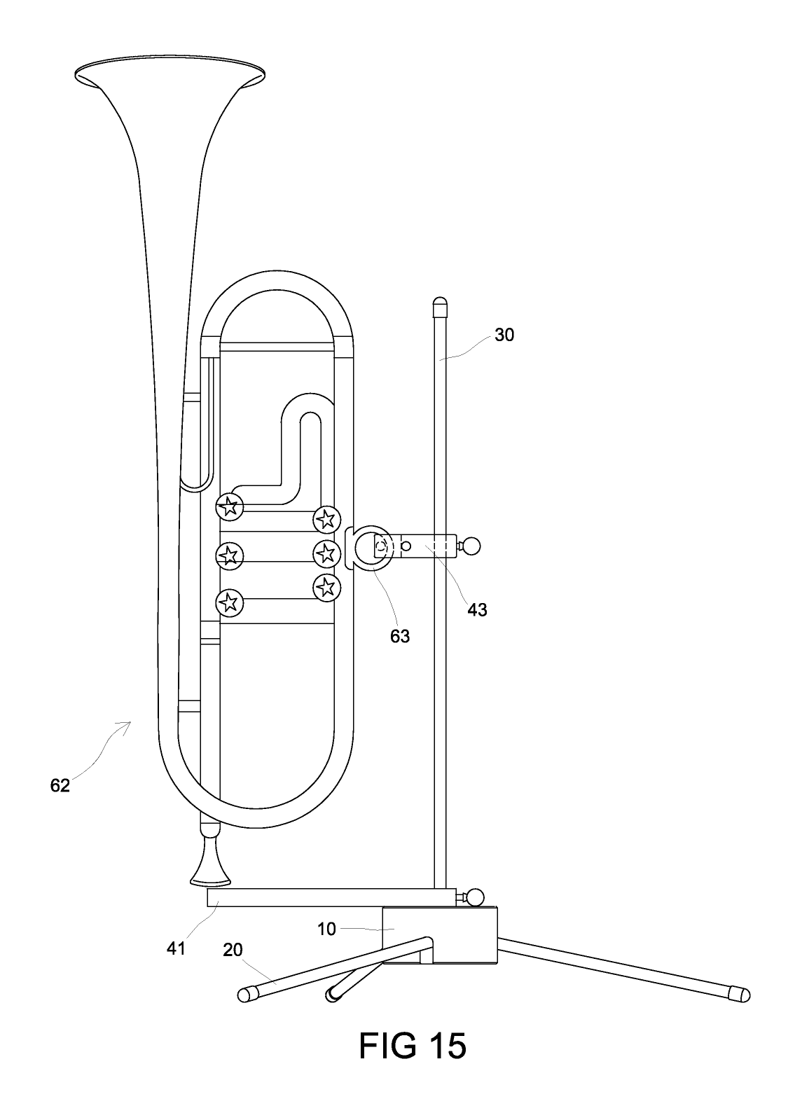

The music support 45 is cooperated with the shaft 30 to support music books. The curved clip 44 is cooperated with the shaft 30 to position a microphone 50. The shaft 30 can be retractable to adjust the height of the music books and the microphone 50 as shown in FIG. 13. The shaft 30 can be directly inserted into the body 61 of the brass from the bell portion, such as a trumpet 60 can be positioned up-side down as shown in FIG. 14. Generally, there is a ring 63 on the trumpet 62, the clip member 43 is used to clip the ring 63 and the support 41 supports the trumpet 62 as shown in FIG. 15. The clip member 43 can also clip the slides of the trumpet 62 which is supported on the support 41.

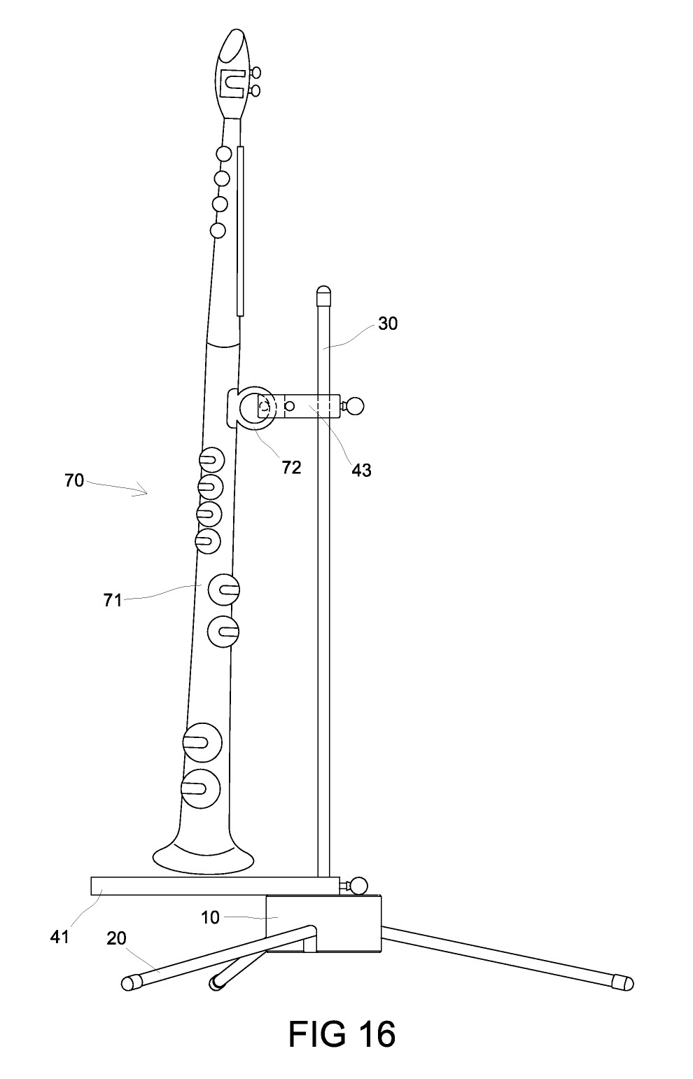

As shown in FIG. 16, the ring 72 of the saxophone 70 can be clipped by the clip member 43, and the saxophone 70 is supported on the support 41. The saxophone 70 can also be arranged up-side down and the shaft 30 is inserted into the body 71 of the saxophone 70.

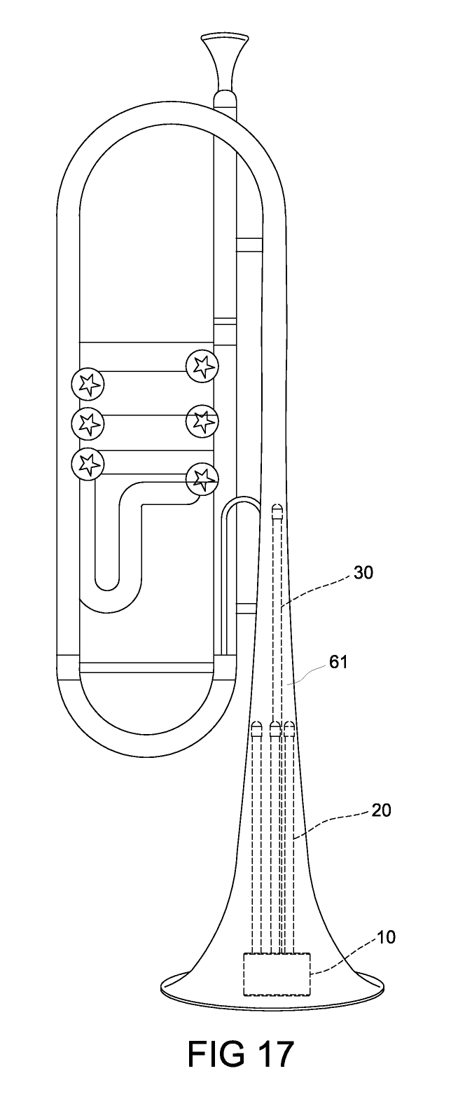

The base 10 can be received in the soprano saxophone or the body 61 of the trumpet 60, and the legs 20 and the shaft 30 are received in the alto saxophone or the tenor saxophone, or the body 61 of the trumpet 60 as shown in FIG. 17.

The three legs 20 evenly support the base 10 and occupy very small area. The music instrument stand of the present invention is durable, light in weight and easily assembled. No rivet, bolt and pin is needed, and is suitable for supporting or positioning any type of music instrument.

While we have shown and described the embodiment in accordance with the present invention, it should be clear to those skilled in the art that further embodiments may be made without departing from the scope of the present invention.

1. A music instrument stand comprising:
a base having at least three recesses and a positioning hole defined in a top thereof, each of the at least three recesses having a flange extending inward from an inner periphery thereof, at least three reception slots defined in an underside of the base and communicating through a periphery of the base, the at least three reception slots located at even distance and angle from each other, each of the at least three reception slots having an inclined inner top which communicates with one of the at least three recesses corresponding thereto;
at least three legs each having an insertion end located in one of the at least three recesses, the at least three legs being received in the at least three reception slots and contacting against the three inclined inner tops, the insertion end of each of the at least three legs having a spherical head which is smaller than an inner diameter of each of the at least three recesses and larger than an inner diameter of the flange of each of the at least three recesses, and
a shaft having an end inserted through the positioning hole and at least one attachment connected to the shaft.

2. (canceled)

3. (canceled)

4. (canceled)

5. The stand as claimed in claim 1, wherein the at least one attachment is a clip member which has a bolt and a through hole, the shaft extends through the through hole and the bolt contacts against the shaft, the clip member has a notch and an insertion hole, a hook-rod extends through the insertion hole, a spring is received insertion hole and mounted to the hook-rod, the hook-rod has a lip extending outward therefrom, the spring is biased between the lip and an inside of the insertion hole, the hook-rod has a hook end which is adapted to hook an object in the notch.

6. The stand as claimed in claim 5, wherein the clip member has a side hole and the shaft extends through the side hole.

7. (canceled)

8. (canceled)
